(19) United States
(12) Patent Application Publication
(10) Pub. No.: US 2010/0323336 A1
(43) Pub. Date: Dec. 23, 2010

(54) ELECTRONIC SYSTEM FOR ASSISTING THE STUDY AND PRACTICE OF MEDICINE

(75) Inventor: Manuel Jorge Vaz da Cunha Guimaraes, Ponte de Lima (PT)

Correspondence Address: ABELMAN, FRAYNE & SCHWAB, 666 THIRD AVENUE, 10TH FLOOR, NEW YORK, NY, 10017, US

(73) Assignee: ALERT LIFE SCIENCES COMPUTING, S.A., Vila Nova de Gaia (PT)

(21) Appl. No.: 12/488,388

(22) Filed: Jun. 19, 2009

(51) Int. Cl. G09B 23/28; G06F 17/30; G06F 7/06

(52) U.S. Cl. 434/262; 707/E17.055; 707/E17.014; 707/710; 707/711

(57) ABSTRACT

An electronic system generates and manages multiple knowledge bases of medical students and practitioners. The knowledge bases are organized according to and for the function of specific limited medical problems. Data regarding each problem cross-references both basic sciences and clinical courses. Users are able to create their own knowledge base with the use of teaching data, their own user generated data, and third party user generated data. Data is dynamically updated, and the knowledge bases support the future medical practice of students.

### BACKGROUND OF THE INVENTION

1. Field of the Invention

This invention relates to an electronic system for assisting students of medicine and other health sciences in their education and their future practice as physicians.

2. Description of the Related Art

Students of medicine have to deal with an enormous amount of information during the course of their education and of their subsequent professional careers. The requirements of both the study and the practice of medicine require students and practitioners to read and process information contained in textbooks, articles, studies, conference papers, statistics, etc. Continuously accelerating scientific and technological progress and innovation in the field of medicine means that this type of information processing is, by definition, a regular and intense activity.

Traditionally, this activity was limited to reading and studying paper-based materials. Any aids or ancillary systems were limited to notes or databases organized by the individual engaged in such activity.

The widespread use of computers and the digitalization of information have significantly transformed the way information is processed by students of medicine and by physicians through facilitating the retrieval, storage, and communication of information. Electronic data systems are known in the art, for example, as described in U.S. Pat. Nos. 5,810,605; 5,823,788; 6,347,333; 6,965,752; 7,024,399; and 7,080,098.

Education institutions use information technology to provide distance learning, and to increasingly deliver training and education materials by electronic means, such as E-learning. This use of information technology by education institutions has also altered the manner in which medical students process information.

Additionally, the Internet has had a profound effect on the way medical students and physicians receive, retrieve, and organize the information they need to process. Library catalogs as well as scientific journals, articles, and digital libraries are widely accessible on the Internet. The use of online discussion forums and more recently of social networking websites as well as “wiki” technology, through the use of computer software that allows users to easily create, edit and link web pages, facilitate in an exponential way the access, interchange, and dissemination of medical information.

Notwithstanding the advances described, two fundamental problems affect the efficacy of the information processing that medical students and practitioners are obliged to do.

One problem relates to the division between basic and clinical science courses. Basic science courses are general disciplines taught in the initial part of medical degrees. Basic science courses include physiology, biochemistry, molecular biology, and anatomy.

Clinical science courses are specific disciplines organized around areas of practice of medicine and are taught in the final part of medical degree programs, normally including practical provision of care. Clinical science courses include surgery, pediatrics, obstetrics, neurology, psychiatry, and radiology.

This means that medical students may not have a comprehension of the structural, functional, and clinical dimensions of human disease when they are studying basic science courses. As a result, the information gathered during those courses is not optimal. Frequently, students confronted with a clinical problem are obliged to re-process information studied during the basic science section of their medical degree. This disconnect is further accentuated by the fact that the teaching staff of the basic science courses are normally not medical doctors.

A second problem relates to the disconnect between the information processed by a person as a medical student and, subsequently, as a medical practitioner. Due to the complexity of the tasks and the enormous pressure and time constraints imposed on medical students, the resulting information available to the medical practitioner is normally retrievable through memory, paper, and digital materials. The comprehensive knowledge base that all medical students must acquire during their degree program is not available in an efficient manner to the medical practitioner.

### BRIEF SUMMARY OF THE INVENTION

The present invention is a system for managing the knowledge bases that are created and used by each individual as medical student, and which is then used by the individual during the length of medical education and future medical practice of the individual.

The system operates on remote servers accessible through the Internet and uses a HyperText Markup Language (HTML) interface, such as a browser or other hardware and/or software, with individual access controls.

Information contained in the knowledge base includes data from three distinct sources. First, the system provides a substantial amount of medical information. This information has been prepared and processed by medical teachers of the relevant teaching institution associated with the individual student user. Second, the user is able to create or add data associated with the user, as well as references to information contained elsewhere. Third, the user may wish to include information created, added, or referred to by other users of the system.

The information that constitutes the knowledge base of each user may take the form of personal notes; scientific papers; textbooks; real, sample, or fictional health records; statistics; and clinical trial results. The ability to create both virtual and real electronic health records with interventions, medical histories, diagnoses and treatment plans of real and/or fictional patients is of particular importance. Virtual electronic health records are used for academic purposes. Real electronic health records allow the user to benefit in detail from the experience of the user as a practitioner. In short, the knowledge base includes reference materials that are used by the medical student and the medical practitioner.

The system uses a problem-oriented learning approach in which all content is based on a limited set of categories associated with a problem or a keyword. The system includes comprehensive information regarding medical data organized around problems, for example, heart failure, cancer, asthma, renal insufficiency, etc. The information is cross-referenced with the complete curriculum of the relevant medical education institution of the users.

Accordingly, every single part of the curriculum of each basic science course is cross-referenced with the relevant aspects of the principle problems in order to provide an adequate context to the student while the student is studying for the basic science courses.

The system uses this problem-centric approach to enable the user to organize the information in the manner which the student prefers. This ability is dynamic as the user is able to create and subsequently alter, as many times as necessary, the way the knowledge base is organized. Similarly, teachers may update the information that students may access through the system. Accordingly, an important aspect of the system is that the curricula of medical schools have to be rewritten or reformatted by teachers in order to aid the way in which information of the curricula is organized. The system must thus be adapted to each applicable curriculum.

A private area of the data included in the system is accessible solely by each individual user, which constitutes an important part of the system. In such a private area, users may create their own knowledge base. Users also have access to public areas and to public collaborative tools such as discussion forums.

Furthermore, the user is able to determine that certain information of the knowledge base, which the user creates, is private or public. Such information may have a default setting of being private, unless the user allows limited or unlimited use by other users or by the public. The user is also able to define specific groups for sharing information, such as the members of a class or a hospital department.

The system also includes certain clinical tools, such as Templates, Alerts, Checklists, and Protocols.

Templates are medical forms where relevant information is recorded which follows suggested topics and which categorizes multiple choices.

Alerts include information that is likely to be relevant to a specific clinical situation. Alerts are prompted when specific situations arise. Alerts can be divided based on the level of importance, nature, and emergency, to be categorized as prompts, useful information, rules, indications, risk factors, differential diagnoses, facts, immunizations, screens, check, suggestion, patient education, refer to the emergency room, and admissions.

Checklists are used to ensure that questions relevant to a problem are correctly addressed by the student during preparation for an exam or by the physician during a patient encounter.

Protocols refer to pathways to be undertaken for problem evaluation during a patient encounter.

The system also includes the embodiment of the SOAP approach. SOAP stands for Subjective (S), Objective (O), Assessment (A), and Plan (P), using the known SOAP notes information organization methodology. SOAP facilitates the teaching and learning processes by focusing on guidance throughout patient encounters. SOAP aims at recording important clinical information and guiding patient care, focusing on how to address clinical problems.

The way the data is organized in the present invention as well as the SOAP approach contribute to a heightened capacity of synthesis using the present invention. This aspect of the system is further enhanced by the user interface that uses a form-like environment where all knowledge directly related to a problem is represented.

In the case of medical students, the sharing of information may be of use for medical teachers that use the system, further enhancing the efficacy of medical teaching methods. A desired result of the use of the system is the creation of a medical knowledge community somewhat similar to a social network including students, teachers, and physicians.

The system also includes self-evaluation tools whereby each problem is associated with specific questions. Answers to the questions generate scores, aiding students in understanding their level of progress.

All the data included in the system is coded with recourse to standard international terminologies. In particular, using the known Systemized Nomenclature of Medicine—Clinical Terms (SNOMED CT) system, the present invention may have a particular complexity and clinical content extension, with more than 300,000 clinical concepts, so the use of SNOMED CT is recommended for keyword association in order to guarantee sensible clinical coding and interoperability with other different electronic information platforms. SNOMED CT-coded keywords relate with each other, by means of particular SNOMED CT relations, or indirectly, through relations from other ontologies.

Other known classification systems such versions of International Classification of Diseases and Related Health Problems, including ICD9/ICD10, as well as the known International Classification of Primary Care such as ICPC2, as well as the Logical Observation Identifiers Names and Codes (LOINC) system, may also be used by the present invention to code specific content, similar problems, diagnoses, lab tests, etc.

Whenever the user is using free text to include information, the system prompts the user, when necessary, to determine or set the coherent terminology which is used. This ensures the efficacy of the search tools available to the user in order to retrieve and access the relevant information.

### BRIEF DESCRIPTION OF THE SEVERAL VIEWS OF THE DRAWINGS

FIG. 1 is a schematic of the system of the present invention, including the ways that users may access and use the system.

FIGS. 2A-2B are schematics illustrating the database models used by the system.

FIG. 3 is a schematic of how the knowledge base of each user is constructed.

FIG. 4 is a schematic illustrating the organizational structure of data.

FIG. 5 is a Venn diagram illustrating the different origins of data contained in the knowledge base.

FIGS. 6A-6B are schematics illustrating the form-like environment of the user interface.

FIG. 7 is a schematic illustrating possible content of the problem-based approach structure.

### DETAILED DESCRIPTION OF THE INVENTION

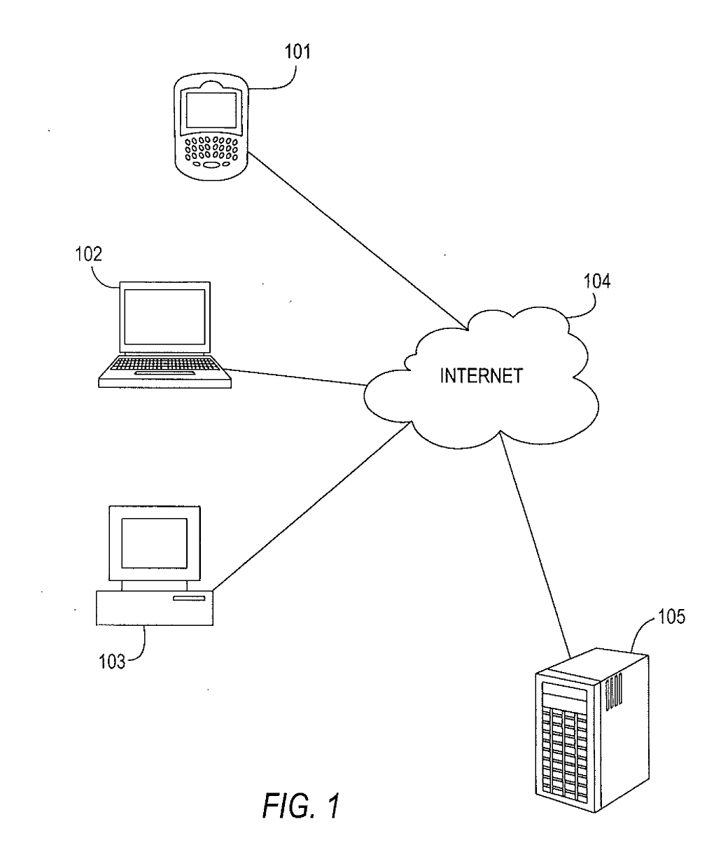

As shown in FIGS. 1-7, the present invention provides an electronic and computer-based system which generates and manages multiple knowledge bases of medical students and practitioners. The knowledge bases are organized according to and for the function of specific limited medical problems. Data regarding each problem cross-references both basic sciences and clinical courses. Users are able to create their own knowledge base with the use of teaching data, their own user generated data, and third party user generated data. Data is dynamically updated, and the knowledge bases support the future medical practice of students.

Users are able to access and use the system by connecting to the Internet with any computing device that is able to connect to the Internet. FIG. 1 illustrates the system of the present invention, including the way users are able to access the system. Commonly used devices such as mobile telephones or personal digital assistants 101 as well as laptop computers 102 and desktop personal computers 103 that incorporate modems connected to communication networks allow users with access accounts to connect to the Internet 104. At least one server 105 hosts the system and data associated with each user, with the data being accessible through the devices 101-103 over the Internet 104. The server 105 includes computer-based components, including processors and other hardware and/or software, operating a predetermined computer program for storing and retrieving information in a knowledge base. The predetermined computer program may include a Structured Query Language (SQL) based program or other known database management programs for organizing, storing, and retrieving the information in the knowledge base. The server 105 may be any known web servers and/or database systems such as an “ORACLE DATABASE” commercially available from “ORACLE CORPORATION”. Access may be protected with known security access features.

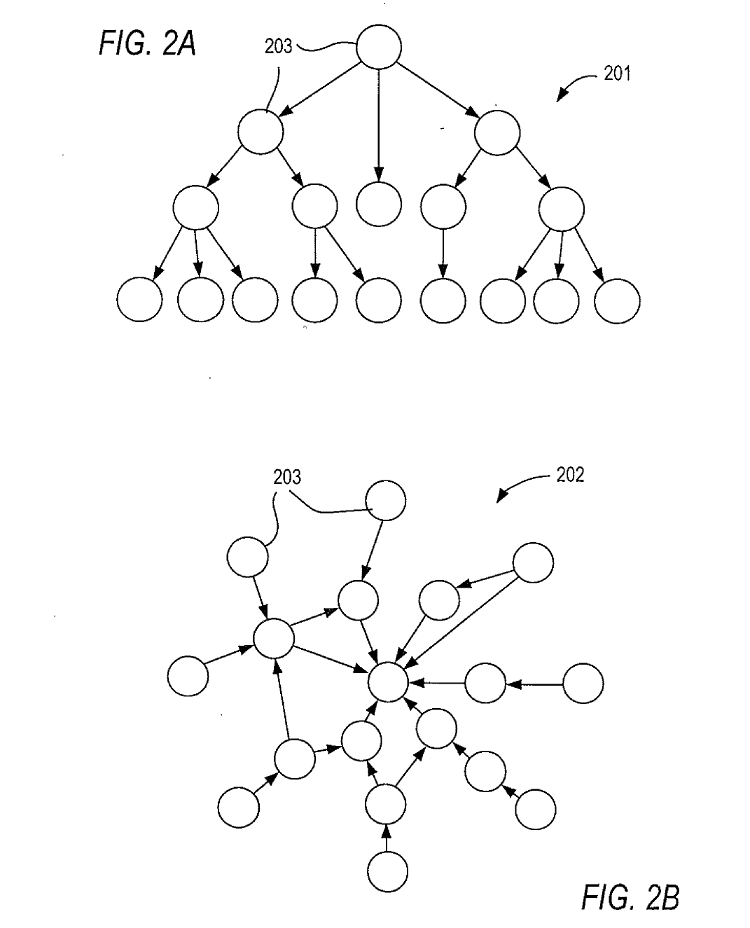

The knowledge base that constitutes the core of the user-associated data hosted by the system is composed of a private section, accessible solely by each individual user, and public sections. FIGS. 2A-2B illustrate how both sections may be organized according to a problem-centric approach. This means that the structure of the database organizes information around specific identified problems. The database may incorporate hierarchical structures 201, as shown in FIG. 2A, as well as network structures 202, as shown in FIG. 2B, with nodes 203 storing and/or processing the information. The structure is in itself not static, since data may be selectively and dynamically compiled, organized, and modified by the system and by the user.

The basic organization of data in the database structures 201-202 may include five major types of data:

a. Fast Facts, which are main ideas about the subject. They represent what is critically necessary to retain.

b. High Yield Glossy Material, which are images, for example, pathology smears, X-rays, pictures of lesions, which may be related to a concept at hand.

c. High Yield Clinical Vignettes, which are clinical situations related to the subject at hand.

d. High Yield Topics, which are general topics such as processes, explanations, and descriptions, which may be related to the subject at hand.

e. High Yield Questions, which are questions to test knowledge on the subject at hand.

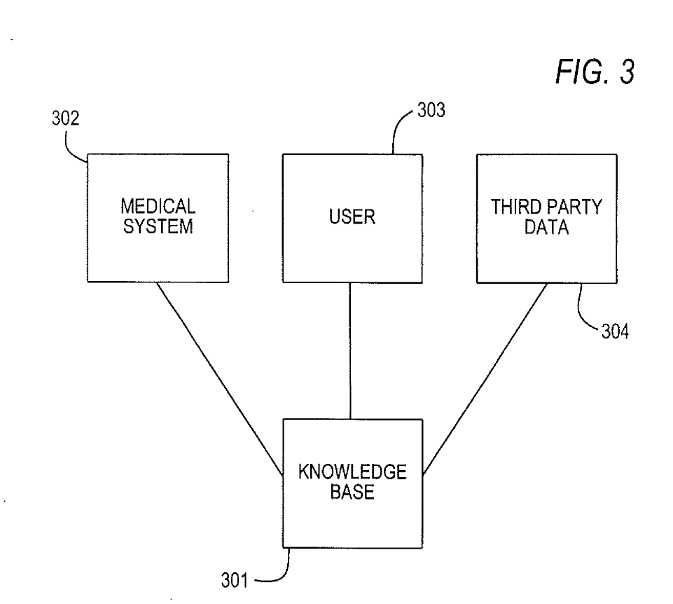

FIG. 3 illustrates the different origins of the data used by the system of the present invention. The knowledge base 301 includes data from three distinct sources: a medical system 302, at least one user 303, and third-party data 304. The information included in the knowledge base 301 of each user may take the form of personal notes, scientific papers, textbooks, real or fictional health records, statistics, clinical trial results, etc. First, a medical system 302 will provide a substantial amount of medical information. The curricula of the relevant medical school may be rewritten or reformatted in order to reflect the problem-centric approach of the system which constitutes the organizational matrix for the user. The information is cross-referenced with the complete curriculum of the relevant medical education institution of the users.

Accordingly, every single part of the curriculum of each basic science course is cross-referenced with the relevant aspects of the principle diseases in order to provide an adequate context to the student while the student is studying in basic science courses.

Second, the user 303 is able to create or add data associated with the specific user 303, as well as referring to information contained elsewhere. The user 303 is able to create both virtual and real electronic health records with interventions, medical histories, diagnoses, and treatment plans of real or fictional patients, which is of particular importance for the medical education of the user 303.

Third, the user 303 may wish to include information created, added, or referred to by other users of the system. This third-party generated data 304 is data which users determine to be useful and which may be accessed by other users who are either students or teachers of the same or different schools.

All of the data contained in the system is coded with recourse to standard international terminologies. Whenever the user is using free text to include information, the system prompts the user, when necessary, to determine which coherent terminology is to be used to ensure the efficacy of the search tools available to the user in order to retrieve and access the relevant information.

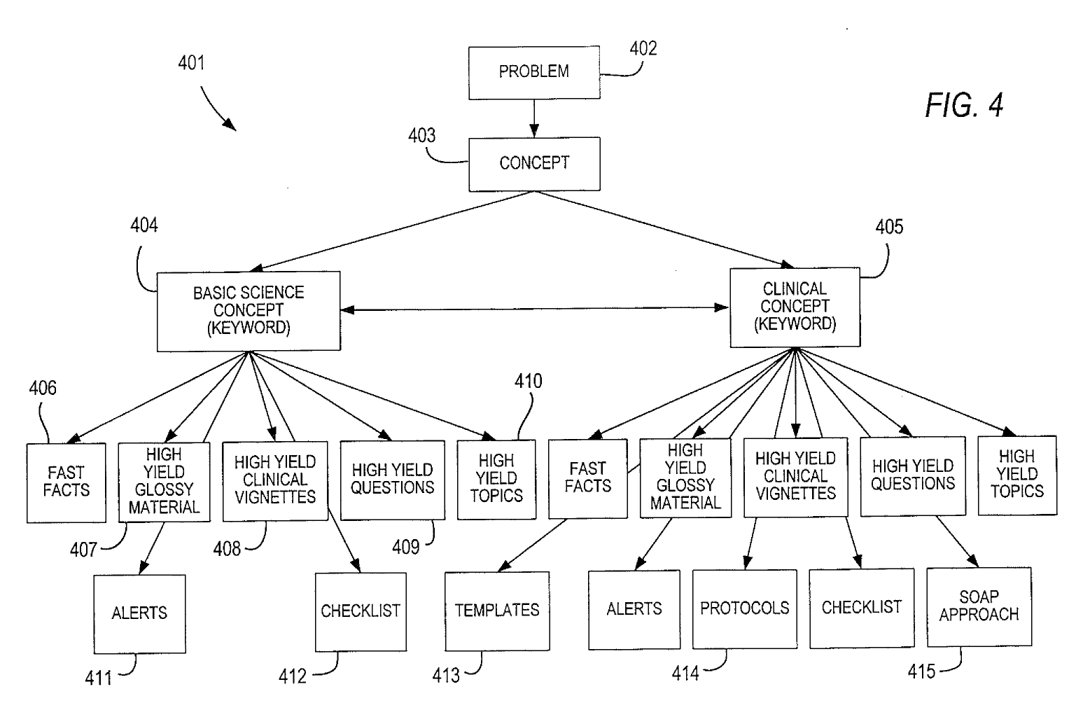

FIG. 4 illustrates the structure 401 of data organized around a specific problem 402, involving a key concept 403. All applicable information regarding such key concepts 403 include keywords relating to basic science concepts 404 and clinical practice concepts 405.

Such concepts 404, 405 are further divided into the five main types of data, such as Fast Facts 406, High Yield Glossy Material 407, High Yield Clinical Vignettes 408, High Yield Questions 409, and High Yield Topics 410; as well as tools such as Alerts 411, Checklists 412, Templates 413, Protocols 414, and other methodologies such as the SOAP approach or SOAP notes 415, each of which is organized around each problem 402.

Templates are medical forms where relevant information is recorded which follows suggested topics and which categorizes multiple choices.

Alerts include information that is likely to be relevant to a specific clinical situation. Alerts are prompted when specific situations arise. Alerts can be divided based on the level of importance, nature, and emergency, to be categorized as prompts, useful information, rules, indications, risk factors, differential diagnoses, facts, immunizations, screens, check, suggestion, patient education, refer to the emergency room, and admissions.

Checklists are used to ensure that questions relevant to a problem are correctly addressed by the student during preparation for an exam or by the physician during a patient encounter.

Protocols refer to pathways to be undertaken for problem evaluation during a patient encounter.

The system also includes the embodiment of the SOAP approach. SOAP stands for Subjective (S), Objective (O), Assessment (A), and Plan (P), using the known SOAP notes information organization methodology. SOAP facilitates the teaching and learning processes by focusing on guidance throughout patient encounters. SOAP aims at recording important clinical information and guiding patient care, focusing on how to address clinical problems.

The way the data is organized in the present invention as well as the SOAP approach contribute to a heightened capacity of synthesis using the present invention. This aspect of the system is further enhanced by the user interface that uses a form-like environment where all knowledge directly related to a problem is represented.

In the case of medical students, the sharing of information may be of use for medical teachers that use the system, further enhancing the efficacy of medical teaching methods. A desired result of the use of the system is the creation of a medical knowledge community somewhat similar to a social network including students, teachers, and physicians.

The system also includes self-evaluation tools whereby each problem is associated with specific questions. Answers to the questions generate scores, aiding students in understanding their level of progress.

All the data included in the system is coded with recourse to standard international terminologies. In particular, using the known SNOMED CT system, the present invention may have a particular complexity and clinical content extension, with more than 300,000 clinical concepts, so the use of SNOMED CT is recommended for keyword association in order to guarantee sensible clinical coding and interoperability with other different electronic information platforms. SNOMED CT-coded keywords relate with each other, by means of particular SNOMED CT relations, or indirectly, through relations from other ontologies.

Other known classification systems such versions of International Classification of Diseases and Related Health Problems, including ICD9/ICD10, as well as the known International Classification of Primary Care such as ICPC2, as well as the Logical Observation Identifiers Names and Codes (LOINC) system, may also be used by the present invention to code specific content, similar problems, diagnoses, lab tests, etc.

Whenever the user is using free text to include information, the system prompts the user, when necessary, to determine or set the coherent terminology which is used. This ensures the efficacy of the search tools available to the user in order to retrieve and access the relevant information.

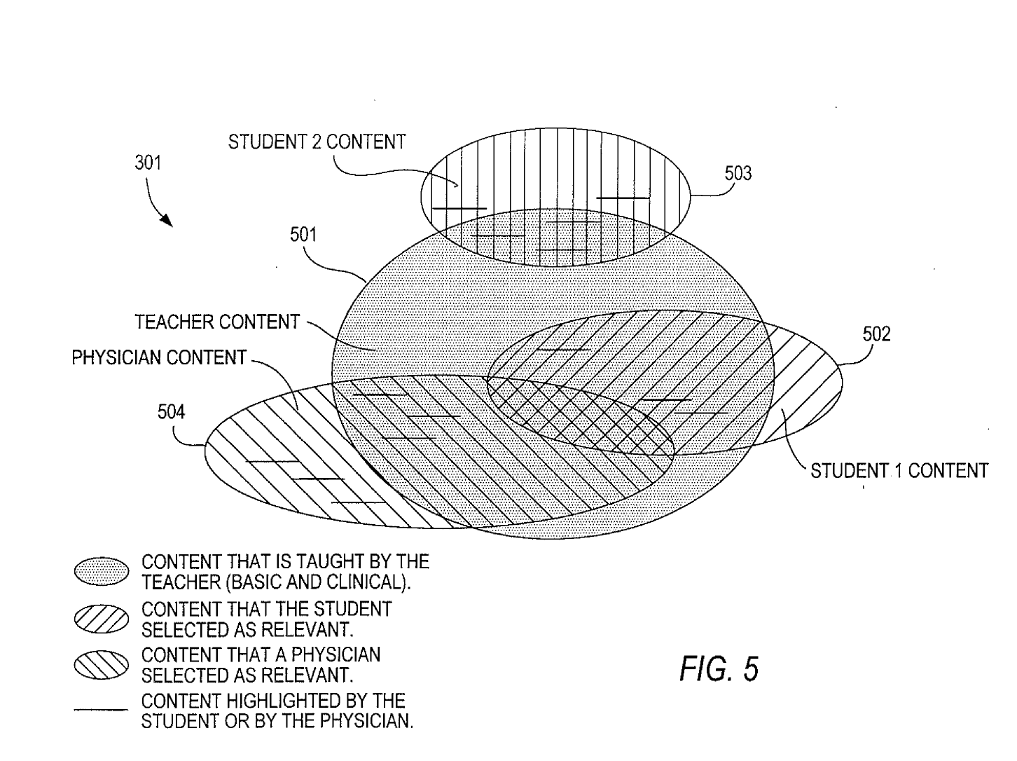

FIG. 5 represents the knowledge stored in the knowledge base 301, and drawn from what is include in the system and taught by the teacher 501 as well as the knowledge that is added and/or highlighted by the student 502, 503 or by a physician 504. The system includes both basic and clinical knowledge. Student content 502, 503 includes the information that is marked as relevant or highlighted by the respective student on the teacher content 501 and/or any other information that the student decides to integrate into his/her individual knowledge database, such as by individual research or by importing content of someone else.

For example, a first student may have associated content 502, and may have access to or link to content 503 of another student, to content 501 of the teacher, or to content 504 of a physician.

On the other hand, the physician may maintain his/her own content 504 throughout his/her professional life, and may be able to add new content as desired. The physician may also update his/her own content by selecting back from the content 501 of a previous teacher through an update mechanism. This ensures dynamic integration of knowledge between each of the key players.

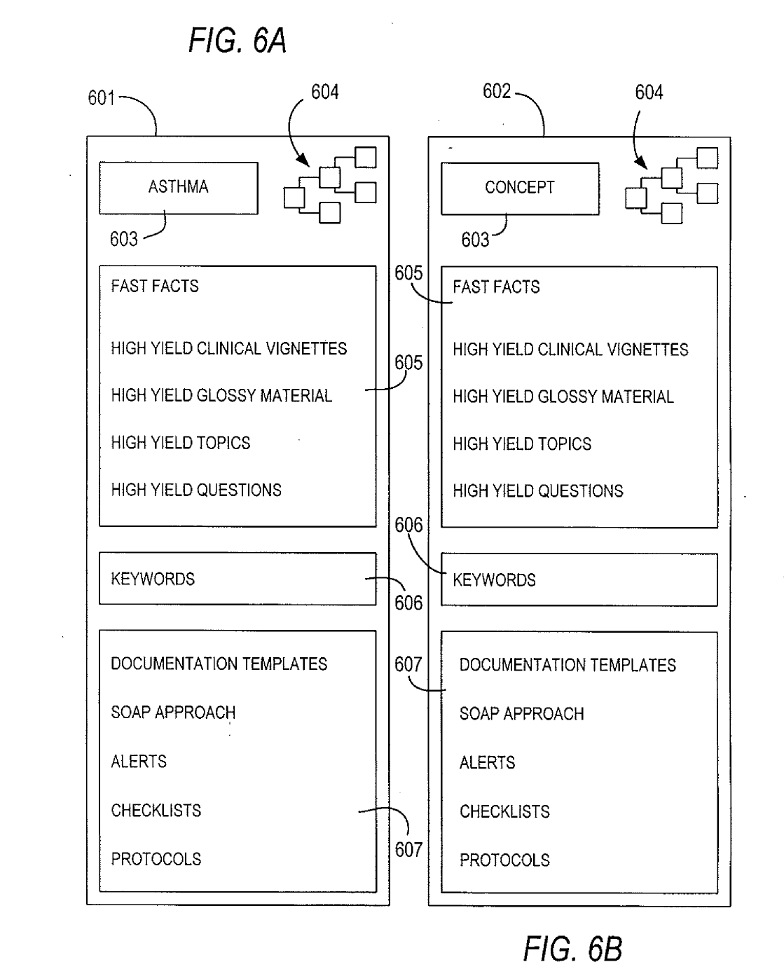

FIGS. 6A-6B illustrate the form-like environment of the interface where the data organized around each problem is displayed in a simple and readable manner. The distinct forms 601, 602 are displayable on a display of a user, such as through a browser or other Internet interfaces with the devices shown and described in connection with FIG. 1.

Each of the forms 601-602 may have a topic display region 603, such as for asthma in form 601, or for a general concept in form 602. The forms may also have a data hierarchy 604, which may correspond to the problems 402 or concepts 403 shown in FIG. 4. The forms 601, 602 may also display various regions 605, 606, 607 of information. A first region 605 of the forms 601, 602 may include the various Fast Facts, High Yield Clinical Vignettes, High Yield Glossy Material, High Yield Topics, and High Yield Questions associated with the topic displayed in region 603.

A second region 606 of the forms 601, 602 may display various keywords associated with the topic displayed in region 603, and a third region 607 of the forms 601, 602 may display additional information such as Documentation Templates, the SOAP approach or SOAP notes, Alerts, Checklists, and Protocols associated with the topic displayed in region 603.

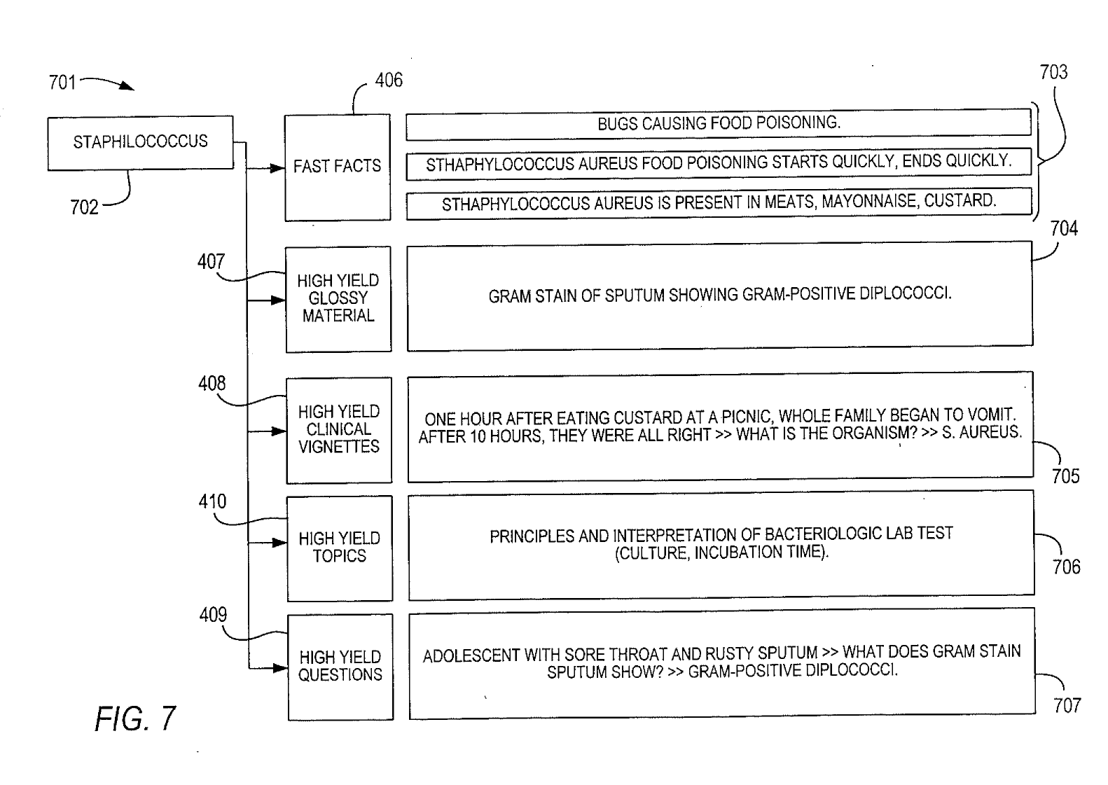

FIG. 7 illustrates an example of the content of the problem based approach structure 701. In this example, the problem is staphylococcus aureus 702, and the data is organized around the five main types of data, such as Fast Facts 406, High Yield Glossy Material 407, High Yield Clinical Vignettes 408, High Yield Questions 409, and High Yield Topics 410. Each type of data is associated with respectively related data in the knowledge database 301 of the system of the present invention, and accessible by the user through the forms 601, 602 in FIG. 6. For example, the Fast Facts 406 may have detailed facts 703 regarding the problem 702, High Yield Glossy Material 407 may have images 704 regarding the problem 702, High Yield Clinical Vignettes 408 may have short but pertinent comments or walkthroughs of diagnoses regarding the problem 702, High Yield Questions 409 may list pertinent questions 707 related to the problem 702, and High Yield Topics 410 may have additional topics 706 to consider related to the problem 702.

Accordingly, using the system of the present invention shown in FIGS. 1-7, the user may readily access and retain information from the student stage of the user to the practitioner stage of the user, for later use and additional modification and access. In operation, the user is able to determine that certain information of the knowledge base, which the user creates, is private or public. Such information may have a default setting of being private, unless the user allows limited or unlimited use by other users or by the public. The user is also able to define specific groups for sharing information, such as the members of a class or a hospital department.

While the preferred embodiment of the present invention has been shown and described herein, it will be obvious that such embodiment is provided by way of example only. Numerous variations, changes and substitutions will occur to those skilled in the art without departing from the invention herein. Accordingly, it is intended that the invention be limited only by the spirit and scope of the appended claims.

What is claimed is:

1. A system for assisting the study and practice of medicine, the system comprising:
a computer-based server operating a predetermined computer program and storing information in a knowledge base associated with a user;
an individual electronic access device by which the user accesses the knowledge base through the Internet using a HyperText Markup Language interface;
wherein the stored information includes a curriculum of a medical teaching institution associated with the user, with the curriculum reformatted to be in a predetermined format for storage and access in the server;
wherein the stored information is organized using a problem-centric organizational structure;
wherein the user, using the predetermined computer program, dynamically creates and modifies the information in the knowledge base associated with the user;
wherein the user, using the predetermined computer program, creates a private section, accessible solely by the user, and storing first selected information in the knowledge base; and
wherein the user, using the predetermined computer program, shares and makes publicly accessible second selected information in the knowledge base.

2. The system of claim 1, wherein the stored information in the server includes medical information from a medical knowledge community of students, teachers and physicians.

3. The system of claim 1, wherein the stored information in the server is coded using a predetermined medical methodology.

4. The system of claim 1, wherein the problem-centric organizational structure of the information uses Templates, Alerts, Checklists and Protocols for accessing and storing the information.

5. The predetermined software program, embodied on a computer readable medium, implementing the system of claim 1.
